(19) United States
(12) Patent Application Publication
(10) Pub. No.: US 2013/0235732 A1
(43) Pub. Date: Sep. 12, 2013

(54) AD HOC NETWORK SYSTEM AND METER READING INFORMATION COLLECTING METHOD

(71) Applicant: HITACHI, LTD., Tokyo (JP)

(72) Inventor: TAIKI NEMA, Tokyo (JP)

(73) Assignee: Hitachi, Ltd., Tokyo (JP)

(21) Appl. No.: 13/784,318

(22) Filed: Mar. 4, 2013

(30) Foreign Application Priority Data
Mar. 6, 2012 (JP) 2012-049191

(51) Int. Cl. H04W 24/02

(52) U.S. Cl. CPC H04W 24/02
USPC 370/241

(57) ABSTRACT

In a system that transmits and receives data through a high-level relay in a mesh ad hoc wireless network including the high-level relay and ad hoc wireless nodes, an increase in data traffic to the high-level relay, and the ad hoc wireless nodes in proximity to the high-level relay, a reduction in use efficiency of a wireless bandwidth of the high-level relay and in the proximity to the high-level relay in association with the increase in the data traffic, and a reduction in the efficiency of an entire mesh ad hoc wireless network are prevented. In the mesh ad hoc wireless network having the high-level relay, and the ad hoc wireless nodes each having a smart meter function unit, meter reading information collection implemented by the high-level relay is delegated to the ad hoc wireless nodes from the high-level relay by one hop, and the use efficiency of the wireless bandwidth in proximity to the high-level relay is improved.

### CLAIM OF PRIORITY

The present application claims priority from Japanese patent application JP 2012-049191 filed on Mar. 6, 2012, the content of which is hereby incorporated by reference into this application.

### BACKGROUND OF THE INVENTION

1. Field of the Invention

The present invention relates to an ad hoc network system and a meter reading information collecting method, and more particularly to an ad hoc network system and a meter reading information collecting method, which collect meter reading information in a mesh ad hoc wireless network.

2. Background Art

In recent years, there has been proposed a system in which a mesh ad hoc wireless network is formed as constituent elements of a smart meter, and meter reading information and control information of the smart meter are communicated on the mesh ad hoc wireless network.

As a background art of this technical field, there is RFC3626 “Optimized Link State Routing Protocol (OLSR)”. This document discloses a technique in which each of wireless nodes notifies a neighborhood of routing information provided in the subject wireless node in a broadcast packet called “annunciation message” whereby each node in the mesh ad hoc wireless network autonomically constructs a channel.

On the other hand, there is Japanese Unexamined Patent Application Publication No. 2001-237764. This publication discloses that one connectable wireless station in which the number of hops obtained by hop number information is smallest is selected as a high-level destination wireless station, and a signal transfer unit transfers a transmit signal or a signal received from a child wireless station to the high-level destination wireless station, or transfers the signal to abase station if the connectable wireless station can be connected directly to the base station. With the above configuration, the publication defines a technique of optimizing the channel of the mesh ad hoc wireless network in which the base station and the child wireless station autonomically select the channel small in the number of hops, determine the channel small in the number of hops as an optimum channel, and transmit a packet.

Also, there is JP-A-2006-211375. This publication defines a communication means that implements the channel selection taking the number of hops as well as a processing load of the node into account to reduce a transmission delay and a packet loss on the channel.

There is JP-A-2006-50371. This publication discloses a data transmitting method that includes a first step of transmitting data from a first terminal to a second terminal with at least another terminal as a data relay terminal, a second step of transmitting a control message for controlling the amount of transmission of relay data from the data relay terminal to the first terminal, and a third step of changing a transmission mode of data addressed to the second terminal according to the contents of the control message by the first terminal. This document defines a data traffic control technique in the ad hoc wireless network.

### SUMMARY OF THE INVENTION

JP-A-2001-237764 defines an autonomic channel constructing technique depending on the number of hops. JP-A-2006-211375 defines an improved channel constructing technique by adding information on the processing load of the node to the autonomic channel construction. JP-A-2006-50371 defines a communication further high in reliability in a system regulating the traffic. However, originally, from the viewpoint of the property of the network that finally collects the information into the high-level relay, problems that the trial number of acquiring wireless transmission rights in proximity to the high-level relay, and the usage of a wireless bandwidth are increased cannot be avoided, and a problem that a communication quality and reliability in proximity to the high-level relay are lessened still remains.

Also, RFC3626 “Optimized Link State Routing Protocol (OLSR)” defines the technique of autonomically constructing the channel of the ad hoc network. JP-A-2001-237764, JP-A-2006-211375, and JP-A-2006-50371 define the technique of selecting the optimum channel so as to lessen a network load in autonomic construction. In the ad hoc wireless network for collecting the meter reading information of the smart meter, even in proximity to the high-level relay and even in the wireless node arranged in a terminal, the bandwidth of the wireless band is not changed, but on the system where each node selects the high-level relay as a destination, as a result that traffic from the respective wireless nodes is collected in proximity to the high-level relay, an increase in the traffic in proximity to the high-level relay, an increase in the trial number of acquiring the wireless transmission rights, and an increase in wireless bandwidth use rate are unavoidable. A problem that the use efficiency of the wireless bandwidth in proximity to the high-level relay is remarkably reduced remains.

Also, in a multicast packet in the ad hoc network, an ad hoc wireless node that receives the multicast packet can implement transfer availability determination only under a hop number control, and the number of packets is increased according to the number of forwarding destination nodes, resulting in a problem that the wireless bandwidth use rate is increased.

In view of the above circumstances, an object of the present invention is to provide an ad hoc wireless network system and a meter reading information collecting method, which prevent the efficiency of the wireless bandwidth from being lessened in proximity to a high-level relay in a system that collects data into the high-level relay in a mesh ad hoc wireless network including a plurality of high-level relays and a plurality of ad hoc wireless nodes.

Another object of the present invention is to realize a communication system that improves a wireless bandwidth use efficiency of a node having a close electric wave in a system that conducts a multicast communication over the network.

In order to solve the above problem, for example, configurations defined in the claims are applied.

The present invention includes a plurality of solutions to the above problem, and one example thereof is that a part or all of meter reading information collection of a high-level relay is delegated to a low-level ad hoc wireless node. Also, a delegation relationship between the high-level relay and the low-level ad hoc wireless node to which the meter reading information collection is delegated is managed by a group ID.

The multicast packet in the ad hoc network is added with control information for each of the group IDs, and an example thereof is that the ad hoc wireless node belonging to a group indicated by the group ID transfers a multicast packet of the group ID, and discards a multicast packet of no group ID.

According to the first solving means of the present invention, there is provided an ad hoc network system, comprising:

a plurality of ad hoc wireless nodes each having a smart meter function unit that measures and transmits meter reading information; and

a high-level relay that receives the meter reading information from the ad hoc wireless nodes,

wherein

the high-level relay selects one or a plurality of ad hoc wireless nodes, of one hop from the subject high-level relay as an alternate relay,

the high-level relay groups the ad hoc wireless nodes that communicate with each other through the alternate relay, and

the high-level relay transmits an alternate relay request including identification information of the grouped ad hoc wireless nodes to the alternate relay,

the alternate relay transmits identification information of the subject alternate relay to the grouped ad hoc wireless nodes,

each of the grouped ad hoc wireless nodes transmits the meter reading information measured by the smart meter function unit to the alternate relay, and

the alternate relay receives the respective meter reading information from the grouped plurality of ad hoc wireless nodes, and transmits the received respective meter reading information and the meter reading information measured by a smart meter storage unit of the subject alternate relay to the high-level relay in a lump.

According to the second solving means of the present invention, there is provided a meter reading information collecting method in an ad hoc network system, comprising:

a plurality of ad hoc wireless nodes each having a smart meter function unit that measures and transmits meter reading information; and

a high-level relay that receives the meter reading information from the ad hoc wireless nodes,

wherein

the high-level relay selects one or a plurality of ad hoc wireless nodes, of one hop from the subject high-level relay as an alternate relay,

the high-level relay groups the ad hoc wireless nodes that communicate with each other through the alternate relay, and

the high-level relay transmits an alternate relay request including identification information of the grouped ad hoc wireless nodes to the alternate relay,

the alternate relay transmits identification information of the subject alternate relay to the grouped ad hoc wireless nodes,

each of the grouped ad hoc wireless nodes transmits the meter reading information measured by the smart meter function unit to the alternate relay, and

the alternate relay receives the respective meter reading information from the grouped plurality of ad hoc wireless nodes, and transmits the received respective meter reading information and the meter reading information measured by a smart meter storage unit of the subject alternate relay to the high-level relay in a lump.

It is possible, according to the present invention, to provide an ad hoc wireless network system and a meter reading information collecting method, which prevent the efficiency of the wireless bandwidth from being lessened in proximity to a high-level relay in a system that collects data into the high-level relay in a mesh ad hoc wireless network including a plurality of high-level relays and a plurality of ad hoc wireless nodes.

In addition, it is possible, according to the present invention, to realize a communication system that improves a wireless bandwidth use efficiency of a node having a close electric wave in a system that conducts a multicast communication over the network.

### BRIEF DESCRIPTION OF THE DRAWINGS

FIG. 1 is a system configuration diagram of a mesh ad hoc wireless network;

FIG. 2 is a functional block diagram of a high-level relay;

FIG. 3 is a functional block diagram of an ad hoc wireless node;

FIG. 4 is a link table of the high-level relay and the ad hoc wireless node;

FIG. 5 is a routing table of the high-level relay and the ad hoc wireless node;

FIG. 6 is an alternate relay management table of the high-level relay;

FIG. 7 is a diagram of processing of selecting an alternate relay, and grouping the affiliation ad hoc wireless nodes;

FIG. 8 is a sequence diagram of designating the alternate relay, and collecting the meter reading information;

FIGS. 9A and 9B are diagrams of frame formats of an alternate relay request and an alternate relay response;

FIG. 10 is a diagram of a frame format of a group ID notification;

FIG. 11 is a diagram of a frame format of the meter reading information;

FIGS. 12A and 12B are diagrams of frame formats of a meter reading completion notification and a meter reading completion response;

FIGS. 13A, 13B, and 13C are diagrams of frame formats of a meter reading information acquisition request and a meter reading completion acquisition response;

FIG. 14 is a sequence diagram configuring a link table and a routing table by an annunciation message notification;

FIGS. 15A and 15B are diagrams of formats of an annunciation message;

FIG. 16 is a diagram of an example of the annunciation message;

FIG. 17 is a diagram of an example of the annunciation message;

FIG. 18 is a diagram of an example of the annunciation message;

FIG. 19 is a diagram of an example of the annunciation message;

FIG. 20 is a diagram of an example of the annunciation message;

FIG. 21 is a sequence diagram of a multicast communication;

FIG. 22 is a diagram of a format of a multicast message;

FIG. 23 is a diagram of an example of the multicast message;

FIG. 24 is a diagram of an example of the multicast message;

FIG. 25 is a diagram of an example of the multicast message; and

FIG. 26 is a diagram of an example of the multicast message.

### DETAILED DESCRIPTION OF THE PREFERRED EMBODIMENTS

Hereinafter, embodiments of the present invention will be described in detail with reference to the accompanying drawings. The substantially same portions are denoted by identical reference numbers, and their description will not be repeated.

### (Hardware Configuration and Table Configuration)

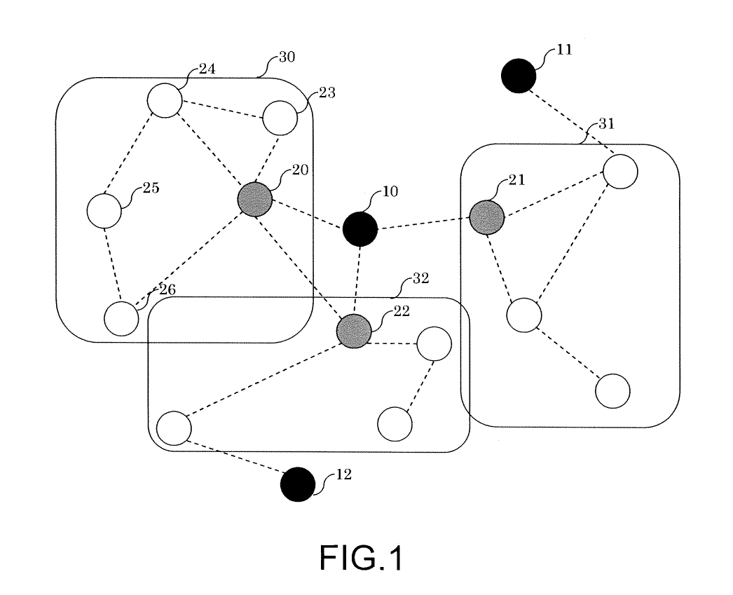

A mesh ad hoc wireless network system will be described with reference to FIG. 1. Referring to FIG. 1, at least one high-level relay 1n (n=0, 1, 2, . . . ) and a plurality of ad hoc wireless nodes 2n (n=0, 1, 2, . . . ) configure a mesh ad hoc wireless network in a wireless communication system conforming to the wireless communication standard defined by, for example, IEEE802.11.

A method of configuring the mesh ad hoc wireless network in the high-level relay 1n (n=0, 1, 2, . . . ) and the ad hoc wireless nodes 2n (n=0, 1, 2, . . . ) can be realized by a mechanism that informs a neighborhood of information on its routing table, with the use of an annunciation message packet by broadcast, for example, and autonomically configures a link table and a routing table, as disclosed in RFC3626 “Optimized Link State Routing Protocol (OLSR)”.

A high-level relay 10 communicates directly with ad hoc wireless nodes 20, 21, and 22. The high-level relay 10 conducts a multi-hop communication with ad hoc wireless nodes 23, 24, 25, and 26 through the ad hoc wireless node 20. The high-level relay 10 relays, for example, meter reading information from the ad hoc wireless node to a meter reading data collection server.

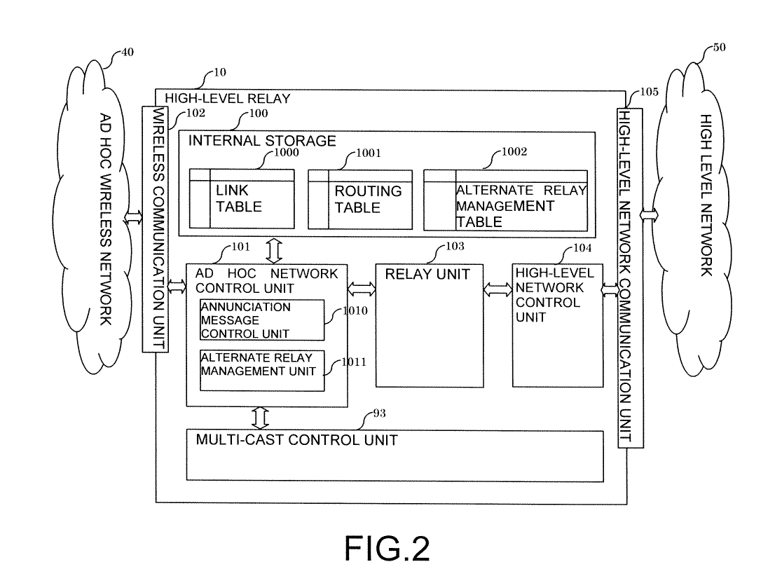

The configuration and the function of the high-level relay 10 will be described with reference to FIG. 2. The high-level relay 10 includes, for example, an internal storage unit (hereinafter referred to as “internal storage”) 100, an ad hoc network control unit 101, a wireless communication unit 102, a relay unit 103, a high-level network control unit 104, a high-level network communication unit 105, and a multi-cast control unit 93.

On the internal storage 100 are disposed at least a link table 1000 that manages the ad hoc wireless nodes that communicate with the high-level relay 10 by one hop, a routing table 1001 that manages the ad hoc wireless nodes 2n (n=0, 1, 2, . . . ) that conduct a communication with the high-level relay 10 by one hop or multi-hop, and an alternate relay management table 1002 that manages the ad hoc wireless nodes 2n (n=0, 1, 2, . . . ) which are selected as alternate relays to which the high-level relay 10 delegates meter reading information collection.

Also, the high-level relay 10 includes an ad hoc network control unit 101, and includes, as a part of the ad hoc network control unit 101, an annunciation message control unit 1010 that updates information on the link table and the routing table, and an alternate relay management unit 1011 that selects and manages the alternate relay. The ad hoc network control unit 101 communicates with the ad hoc wireless nodes 2n (n=0, 1, 2, . . . ) present on the ad hoc network through the wireless communication unit 102 that controls a physical media access.

After receiving the meter reading information received from an ad hoc network 40 through the wireless communication unit 102, the high-level relay 10 transmits the meter reading information to a high level network 50 from the high-level network communication unit 105 through the ad hoc network control unit 101, the relay unit 103, and the high-level network control unit 104.

The high-level relay 10 includes the multi-cast control unit 93 that conducts transmission and reception control of the multi-cast, and conducts multi-cast communication on the ad hoc wireless network through the ad hoc network control unit 101 according to the multicast message.

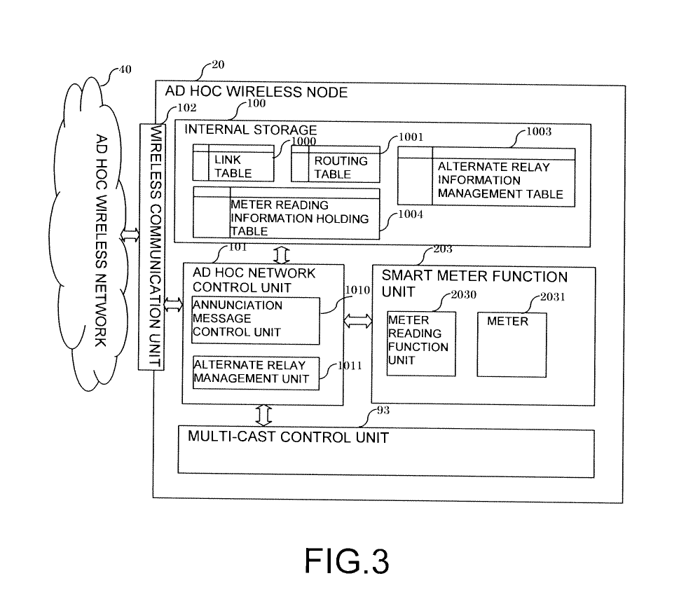

The configuration and the function of the ad hoc wireless node 20 will be described with reference to FIG. 3. The ad hoc wireless node 20 includes the internal storage unit (hereinafter referred to as “internal storage”) 100, the ad hoc network control unit 101, the wireless communication unit 102, a smart meter function unit 203, and the multicast control unit 93.

On the internal storage 100 are disposed information on at least the link table 1000 that manages other ad hoc wireless nodes 2n (n=0, 1, 2, . . . ) that communicate with the subject ad hoc wireless node by one hop, and the high-level relays 1n (n=0, 1, 2, . . . ) that communicate with the subject ad hoc wireless node by one hop, the routing table 1001 that manages the ad hoc wireless nodes and the high-level relay 10 which conduct a communication with each other by one hop or a multi-hop from the ad hoc wireless nodes 2n (n=0, 1, 2, . . . ), an alternate relay information management table 1003 that manages the high-level alternate relay, and a meter reading information holding table 1004 that temporarily buffers the meter reading information of the ad hoc wireless nodes 2n (n=0, 1, 2, . . . ) put under the control, which is used when the ad hoc wireless node is selected as the alternate relay.

Also, the ad hoc wireless nodes 2n (n=0, 1, 2, . . . ) each have the ad hoc network control unit 101, and includes the annunciation message control unit 1010 that updates information on the link table and the routing table, and the alternate relay management unit 1011 that selects and manages the alternate relay, as a part of the ad hoc network control unit 101.

The ad hoc wireless nodes 2n (n=0, 1, 2, . . . ) have the smart meter function unit 203, and includes a meter reading control unit 2030 and a meter 2031, which implement the meter reading of the smart meter.

The meter reading control unit 2030 periodically reads a meter reading value, and transmits the meter reading information to the ad hoc network 40 with the high-level relay 1n (n=0, 1, 2, . . . ) or the alternate relay as a final destination, through the ad hoc network control unit 101 and the wireless communication unit 102. In this example, an electric power can be used as an example of the meter reading information, but appropriate measurement data may be used apart from the electric power. Also, plural pieces of measurement data may be included.

The ad hoc wireless nodes 2n (n=0, 1, 2, . . . ) each have the multi-cast control unit 93 that controls transmission and reception of the multicast, and conduct a multicast communication through the ad hoc network control unit 101 on the ad hoc wireless network according to a multicast message.

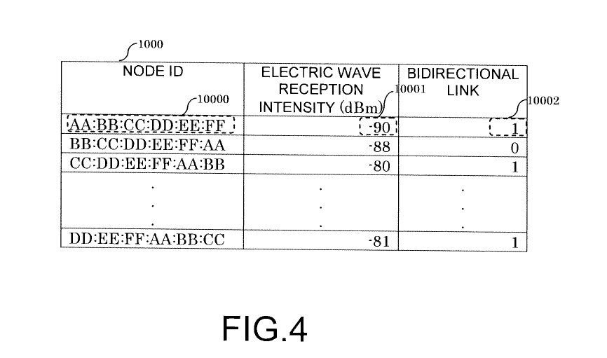

A description will be given of the link table 1000 which is held within the internal storage 100 of the high-level relay 10, and the link table 1000 which is held within the internal storage 100 of the ad hoc wireless node 20, with reference to FIG. 4. The link tables 1000 manage the respective nodes of one hop from their devices. The link table 1000 has a node ID 10000 of the node of one hop from at least its devices, and has a parameter for evaluating the communication quality of the link in correspondence with the node ID 10000, as an example, has respective information of a electric wave reception intensity 10001, and identification information of a bidirectional link 10002 indicating whether the link is bidirectional, or not. As illustrated in FIG. 3, the node ID 10000 is, for example, an identifier that uniquely determines the ad hoc wireless nodes 2n (n=0, 1, 2, . . . ) and the high-level relay 1n (n=0, 1, 2, . . . ) such as an MAC address.

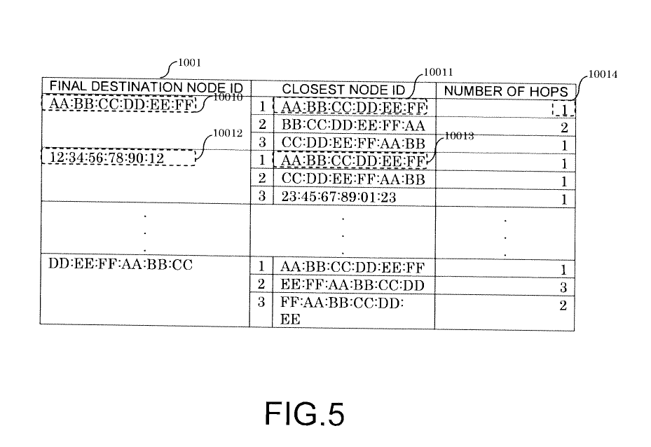

FIG. 5 illustrates the routing table 1001 which is held within the internal storage 100 of the high-level relay 10, and the routing table 1001 which is held within the internal storage 100 of the ad hoc wireless node 20. The routing table 1001 has information on the ad hoc wireless nodes 2n (n=0, 1, 2, . . . ) that communicates with the high-level relay 10 by one hop or a multi-hop. The information internally held includes at least a final destination node ID 10010, and a closest node ID 10011. The final destination node ID 10010 and the closest node ID 10011 are, for example, identifiers that uniquely determine the ad hoc wireless nodes 2n (n=0, 1, 2, . . . ) of the final destination and the high-level relay 1n (n=0, 1, 2, . . . ), such as an MAC address. The plurality of closest node IDs 10011 can be held for one final destination node ID 10010. In an example of FIG. 5, three closest node IDs 10011 are held for one final destination node ID. The closest node ID which is one element of the routing table 1001 of the high-level relay 10 and the ad hoc wireless node 20 is present as the entry within the link table 1000.

When the high-level relay 10 and the ad hoc wireless node 20 transmit data to the final destination node, one node is selected from the plurality of closest node IDs 10011 corresponding to the final destination node ID 10010, and the data is transmitted to the closest node ID. As one example, among the corresponding plural closest nodes, the closest node whose electric wave reception intensity 10001 is higher than a predetermined reference, and which establishes a bidirectional link 10002 is selected preferentially, as exemplified by FIG. 4. The node that receives the data selects the closest node through the same operation, and propagates the data to the final destination by multi-hop.

The configuration of the link table 1000 exemplified in FIG. 4 and the routing table 1001 exemplified in FIG. 5 can be realized by an annunciation message mutual communication between the high-level relay and the ad hoc wireless node, and between the ad hoc wireless node and the ad hoc wireless node, as disclosed in RFC3626 “Optimized Link State Routing Protocol (OLSR)”. In the high-level relay 10, the construction of the link table 1000 exemplified in FIG. 4, and the routing table 1001 exemplified in FIG. 5 is realized by the annunciation message control unit 1010 which is a part of the ad hoc network control unit 101 illustrated in FIG. 2. In the ad hoc wireless node 20, the configuration functions of the link table 1000 exemplified in FIG. 4 and the routing table 1001 exemplified in FIG. 5 are realized by the annunciation message control unit 1010 which is a part of the ad hoc network control unit 101 illustrated in FIG. 3.

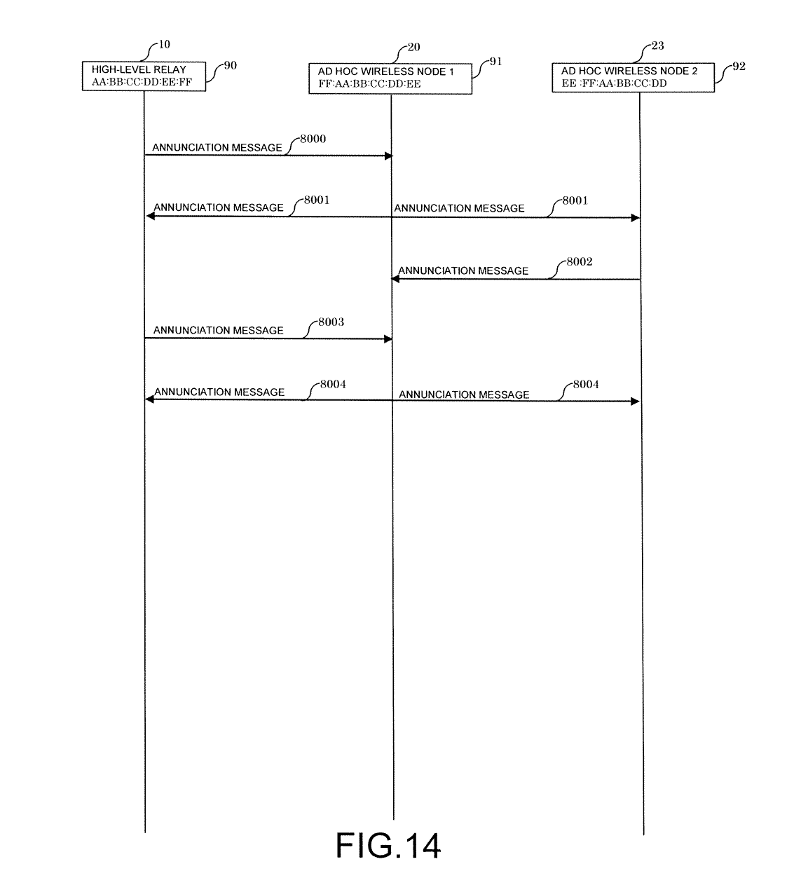

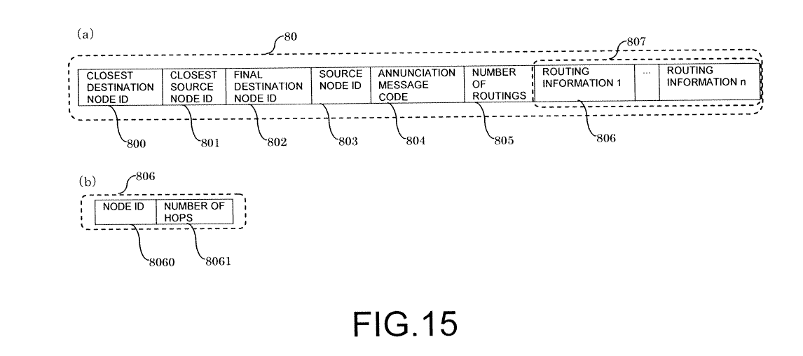

Also, another example of the configurations of the link table 1000 and the routing table 1001 which are realized by the annunciation message control unit 1010 will be described with reference to FIGS. 14 and 15. FIG. 15 illustrates a format of an annunciation message 80.

The annunciation message 80 includes a closest node ID 800, a closest source node ID 801, a final destination node ID 802, a source node ID 803, an annunciation message code 804, number of routings 805, and routing information 806.

The closest node ID 800 holds a broadcast address, the closest source node ID 801 holds the high-level relay 1n (n=0, 1, 2, . . . ) which is the closest source, or a node ID of the ad hoc wireless nodes 2n (n=0, 1, 2, . . . ). The final destination node ID 802 holds a broadcast address, the source node ID 803 holds the high-level relay 1n (n=0, 1, 2, . . . ) which is a source, or the node ID of the ad hoc wireless nodes 2n (n=0, 1, 2, . . . ). The annunciation message code 804 holds a predetermined integer value which indicates an annunciation message. The number of routings 805 holds the number of routings (the number of routing information) included in the annunciation message 80, and the routing information 806 holds the routing information of the source. The above-mentioned integer value held by the message may be appropriate identification information other than the integer value. The same is applied to the messages and data formats which will be described below.

As illustrated in FIG. 15B, routing information 806 holds the routing enable node ID 8060 and a number of hops 8061. The routing information 806 holds a number of routing enable nodes 807 which is held within the routing table 1001 by the source node. The routing enable node ID 8060 of the number of routing enable nodes 806 is exemplified by the final destination node ID 10010 illustrated in FIG.5, and the number of hops 8061 is exemplified by a number of hops 10014 illustrated in FIG. 5.

The details of the operation will be described with reference to FIGS. 14, 16, 17, 18, 19, 20, and 21. In this example, the ad hoc wireless node 20 comes close to, and can communicate directly with the high-level relay 10 and the ad hoc wireless node 23.

In an initial state, no entry is present in the link table 1000 and the routing table 1001 of the high-level relay 10, the ad hoc wireless node 20, the ad hoc wireless node 23,

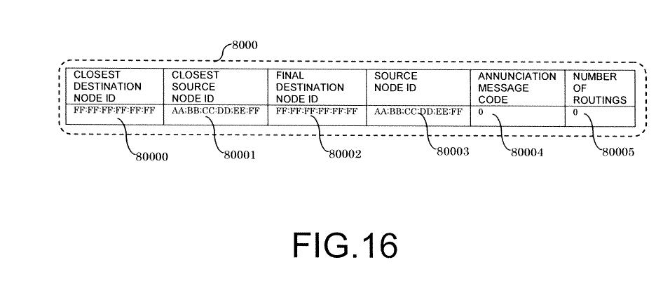

The high-level relay 10 transmits an annunciation message 8000 to one hop from the high-level relay 10. FIG. 16 illustrates an example of the annunciation message 8000.

As the contents of the annunciation message 8000, a closest destination node ID 80000 has FF:FF:FF:FF:FF:FF indicative of the broadcast, a closest source node ID 80001 has a node ID 90 of the high-level relay 10 which is a source node. A final destination node ID 80002 has FF:FF:FF:FF:FF:FF indicative of the broadcast. A source node ID 80003 has the node ID 90 of the high-level relay 10 which is a source node. An annunciation message code 80004 has a predetermined integer value (0 in the example of FIG. 16) indicative of an annunciation message. A number of routings 80005 has 0 because no routing information is present in the initial state. Because no routing information is provided, the routing information 806 illustrated in FIG. 15 is not included in the annunciation message 8000.

The ad hoc wireless node 20 that receives the annunciation message 8000 recognizes that the high-level relay 10 is present in proximity to the ad hoc wireless node 20. As one entry of the link table 1000 of itself, the node ID 90 of the high-level relay 10 which is the source is set for the node ID 10000. The electric wave reception intensity when receiving the electric wave is registered in the electric wave reception intensity 10001, and for example, 0 is set for a bidirectional link 10002. The ad hoc wireless node 20 that receives the annunciation message 8000 sets the node ID 90 of the high-level relay 10 of the source for the final destination node ID 10010 of the routing table 1001 of itself, sets the node ID 90 of the high-level relay 10 of the source for the closest node ID 10011, and 1 is set for the number of hops 10014 because the annunciation message 8000 is received directly from the high-level relay 10.

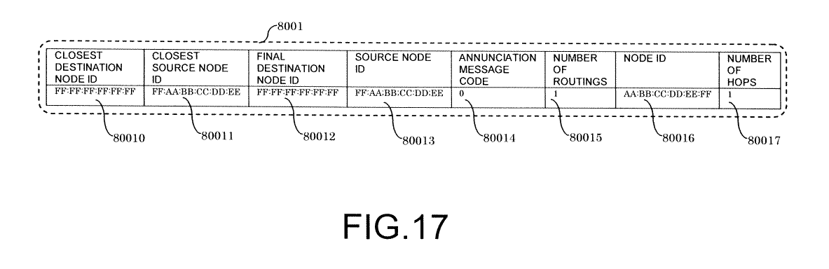

The ad hoc wireless node 20 transmits an annunciation message 8001 to one hop from the ad hoc wireless node 20. FIG. 17 illustrates an example of the annunciation message 8001. As the contents of the annunciation message 8001, a final destination node ID 80010 has FF:FF:FF:FF:FF:FF indicative of the broadcast. A closest source node ID 80011 has a node ID 91 of the ad hoc wireless node 20 which is a source node. A final destination node ID 80012 has FF:FF:FF:FF:FF:FF indicative of the broadcast. A source node ID 80013 has the node ID 91 of the ad hoc wireless node 20 which is a source node. An annunciation message code 80014 has a predetermined integer value representing that the annunciation message is present (0 in the illustration of FIG. 17). A number of routings 80015 has the number of entries of the routing table 1000 (1 in this case) configured at the time of receiving the annunciation message 8000. A node ID 80016 has the node ID 90 of the high-level relay 10 which is one information of the routing table 1000 configured at the time of receiving the annunciation message 8000. A number of hops 80017 has the number of hops of the high-level relay 10 which is one information of the routing table 1000 configured at the time of receiving the annunciation message 8000.

The high-level relay 10 that receives the annunciation message 8001 recognizes that the ad hoc wireless node 20 is present in proximity to the high-level relay 10, and registers the ad hoc wireless node ID 91 of the source in the node ID 10000 as one entry of the link table 1000 of itself. The high-level relay 10 also registers the electric wave reception intensity at the time of reception in the electric wave reception intensity 10001. Also, in the high-level relay 10, the node ID 80016 which is a part of the routing information of the annunciation message 8001 is the node ID 90 of the high-level relay 10 per se, and the number of hops 80017 is 1. Therefore, 1 (a value indicating that a bidirectional link is present) is set for the bidirectional link 10002 of the link table entry.

In the high-level relay 10 that receives the annunciation message 8001, the node ID 91 of the ad hoc wireless node 20 of the source is set for the final destination node ID 10010 of the routing table 1001 of itself. The node ID 91 of the ad hoc wireless node 20 is set for the closest node ID 10011, and 1 is set for the number of hops 10014 because the annunciation message 8001 is received directly from the ad hoc wireless node 20.

The annunciation message 8001 is also received by the ad hoc wireless node 23. The ad hoc wireless node 23 recognizes that the ad hoc wireless node 20 is present in proximity to the ad hoc wireless node 23, and as one entry of the link table 1000 of itself, registers the ad hoc wireless node ID 91 of the source in the node ID 10000, and the electric wave reception intensity at the time of reception in the electric wave reception intensity 10001. Also, the ad hoc wireless node 23 sets 0 for the bidirectional link 10002 of the link table entry because the node ID 80017 which is a part of the routing information of the annunciation message 8001 is not a node ID 92 of the received ad hoc wireless node 23 per se.

The ad hoc wireless node 23 that receives the annunciation message 8001 sets, as one entry of the routing table 1001 of itself, the node ID 91 of the ad hoc wireless node 20 of the source for the final destination node ID 10010. Also, the ad hoc wireless node 23 sets the node ID 91 of the ad hoc wireless node 20 for the closest node ID 10011, and sets 1 for the number of hops 10014 because the annunciation message 8001 is received directly from the ad hoc wireless node 20. Also, the ad hoc wireless node 23 sets, as another entry, the node ID 80016 of the routing information for the final destination node ID 10010. The ad hoc wireless node 23 also sets the node ID 91 of the ad hoc wireless node 20 which is a direct source of the annunciation message 8001 for the closest node ID 10011, and sets a value obtained by adding 1 for the number of hops 80017 of the routing information.

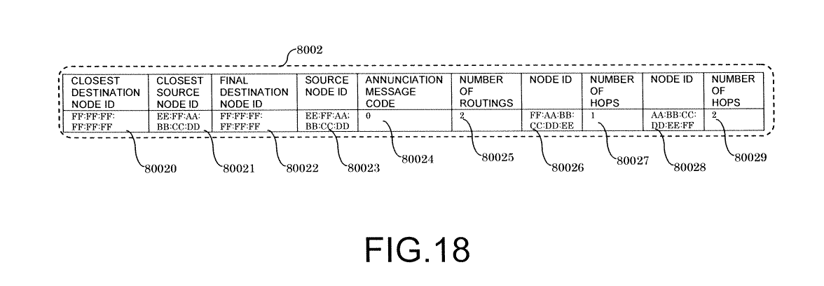

The ad hoc wireless node 23 transmits an annunciation message 8002 to one hop from the ad hoc wireless node 23. FIG. 18 illustrates an example of the annunciation message 8002. As the contents of the annunciation message 8002, a closest destination node ID 80020 has FF:FF:FF:FF:FF:FF indicative of the broadcast. A closest source node ID 80021 has the node ID 92 of the ad hoc wireless node 23 which is the source node. A final destination node ID 80022 has FF:FF:FF:FF:FF:FF indicative of the broadcast. A source node ID 80023 has the node ID 92 of the ad hoc wireless node 23 which is a source node. An annunciation message code 80024 has a predetermined integer value representing that the annunciation message is present (0 in the illustration of FIG. 18). A number of routings 80025 has the number of entries of the routing table 1000 (2 in this case) configured at the time of receiving the annunciation message 8001. A node ID 80026 has the node ID 91 of the ad hoc wireless node 20 which is one information of the routing table 1000 configured at the time of receiving the annunciation message 8001. A number of hops 80027 has the number of hops of the node ID 91 of the ad hoc wireless node 20 which is one information of the routing table 1000 configured at the time of receiving the annunciation message 8001. Anode ID 80028 has the node ID 90 of the high-level relay 10 which is another information of the routing table 1000 configured at the time of receiving the annunciation message 8001. A number of hops 80029 has the number of hops of the node ID 90 of the high-level relay which is another information of the routing table 1000 configured at the time of receiving the annunciation message 8001.

The ad hoc wireless node 20 that receives the annunciation message 8002 recognizes that the ad hoc wireless node 23 is present in proximity to the ad hoc wireless node 20, and as one entry of the link table 1000 of itself, registers the node ID 92 of the ad hoc wireless node 23 of the source in the node ID 10000, and the electric wave reception intensity at the time of reception in the electric wave reception intensity 10001. Also, the ad hoc wireless node 20 sets 1 for the bidirectional link 10002 of the link table entry because the node ID 80027 which is a part of the routing information of the annunciation message 8002 is the node ID 91 of the ad hoc wireless node 20 per se, and the number of hops 80028 is 1.

Also, the ad hoc wireless node 20 that receives the annunciation message 8002 sets the node ID 91 of the ad hoc wireless node 23 of the source for the final destination node ID 10010 of the routing table 1001 of itself. Also, the ad hoc wireless node 20 sets the node ID 91 of the ad hoc wireless node 23 of the source for the closest node ID 10011, and sets 1 for the number of hops 10014 because the annunciation message 8002 is received directly from the ad hoc wireless node 23. Also, the ad hoc wireless node 20 registers the information whose node ID is not the node ID of itself among the routing information in the routing table 10001 of itself. For example, the ad hoc wireless node 20 sets, as another entry, the node ID 80028 of the routing information for the final destination node ID 10010, sets the node ID 92 of the ad hoc wireless node 23 which is a direct source of the annunciation message 8002 for the closest node ID 10011, and sets a value obtained by adding 1 to the number of hops 80029 of the routing information for the number of hops 10014.

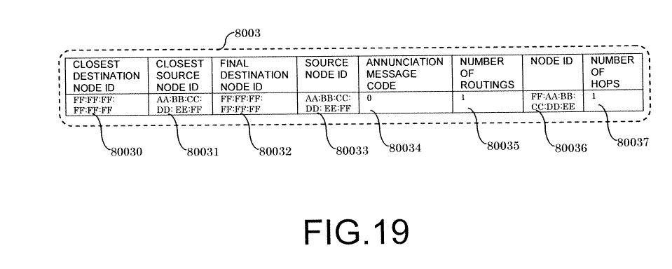

The high-level relay 10 transmits an annunciation message 8003 to one hop from the high-level relay 10. FIG. 19 illustrates an example of the annunciation message 8003. As the contents of the annunciation message 8003, a closest destination node ID 80030 has FF:FF:FF:FF:FF:FF indicative of the broadcast, a closest source node ID 80031 has the node ID 90 of the high-level relay 10 which is a source node. A final destination node ID 80032 has FF:FF:FF:FF:FF:FF indicative of the broadcast. A source node ID 80033 has the node ID 90 of the high-level relay 10 which is a source node. An annunciation message code 80034 has a predetermined integer value (0 in the example of FIG. 19) indicative of an annunciation message. A number of routings 80035 has the number of entries (1 in this case) of the routing table 1000 configured at the time of receiving the annunciation message 8001. A node ID 80036 has the node ID 91 of the ad hoc wireless node 20 which is one information of the routing table 1000 configured at the time of receiving the annunciation message 8001. A number of hops 80037 has the number of hops of the node ID 91 of the ad hoc wireless node 20 which is one information of the routing table 1000 configured at the time of receiving the annunciation message 8001.

The ad hoc wireless node 20 that receives the annunciation message 8003 searches the entry of the node ID 90 of the high-level relay 10 which is one entry registered in the routing table 1001 at the time of receiving the annunciation message 8000, to update the electric wave reception intensity 10001 at the time of reception. The ad hoc wireless node 20 changes the bidirectional link 10002 of the link table entry to 1 because the node ID 80037 which is a part of the routing information of the annunciation message 8003 is the node ID 91 of the ad hoc wireless node 20 per se and the number of hops 80038 is 1. The ad hoc wireless node 20 that receives the annunciation message 8003 does not change the routing table because there is no change in the final destination node ID 10010 in the routing table 1000 configured at the time of receiving the annunciation message 8000, and the node ID 80036, and there is no change in the number of hops 10014 and the number of hops 80037.

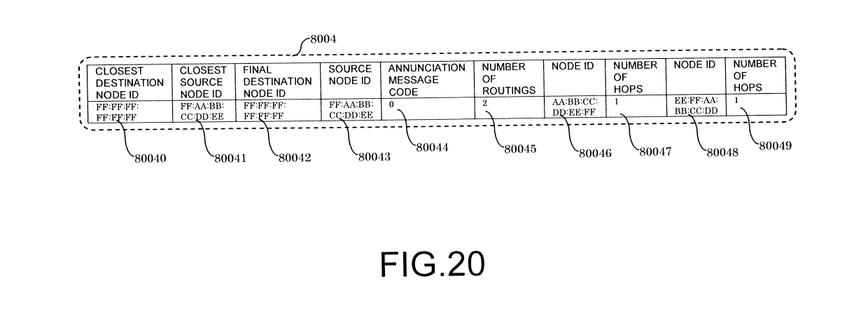

The ad hoc wireless node 20 transmits an annunciation message 8004 to one hop from the ad hoc wireless node 20. FIG. 20 illustrates an example of the annunciation message 8004. As the contents of the annunciation message 8004, a final destination node ID 80040 has FF:FF:FF:FF:FF:FF indicative of the broadcast. A closest source node ID 80041 has the node ID 91 of the ad hoc wireless node 20 which is a source node. A final destination node ID 80042 has FF:FF:FF:FF:FF:FF indicative of the broadcast. A source node ID 80043 has the node ID 91 of the ad hoc wireless node 20 which is a source node. An annunciation message code 80044 has an integer value representing that the annunciation message is present (0 in the illustration of FIG. 19). A number of routings 80045 has the number of entries (2 in this case) of the routing table 1000 configured at the time of receiving the annunciation messages 8000 and 8002. A node ID 80046 has the node ID 90 of the high-level relay 10 which is one information of the routing table 1000 configured at the time of receiving the annunciation message 8000. A number of hops 80047 has the number of hops of the node ID 90 of the high-level relay 10 which is one information of the routing table 1000 configured at the time of receiving the annunciation message 8000. Anode ID 80048 and a number of hops 80049 have the respective information of the link table 1000 configured at the time of receiving the annunciation message 8002.

The high-level relay 10 that receives the annunciation message 8004 searches the entry of the node ID 91 of the ad hoc wireless node 20 which is one entry registered in the routing table 1001 at the time of receiving the annunciation message 8001, to update the electric wave reception intensity 10001 at the time of reception. The high-level relay 10 that receives the annunciation message 8004 does not update the routing table because there is no change in the final destination node ID 10010 of the routing table 1000 configured at the time of receiving the annunciation message 8001, and the node ID 80046, and there is no change in the number of hops 10014 and the number of hops 80047.

The ad hoc wireless node 23 that receives the annunciation message 8004 searches the entry of the node ID 91 of the ad hoc wireless node 20 which is one entry registered in the link table 1001 at the time of receiving the annunciation message 8001, to update the electric wave reception intensity 10001 at the time of reception. The ad hoc wireless node 23 that receives the annunciation message 8004 does not update the entry of the routing table related to the node ID 80046 because there is no change in the final destination node ID 10010 of the routing table 1000 configured at the time of receiving the annunciation message 8001, and the node ID 80046, and there is no change in the number of hops 10014 and the number of hops 80047. Also, the ad hoc wireless node 23 sets, as another entry of the routing table of itself, the node ID 80048 of the routing information for the final destination node ID 10010. Also, the ad hoc wireless node 23 sets the node ID 91 of the ad hoc wireless node 20 which is a direct source of the annunciation message 8004 for the closest node ID 10011, and sets a value obtained by adding 1 for the number of hops 80049 of the routing information for the number of hops 10014.

Through the above procedure, the link table 1000 and the routing table 1001 are configured by the annunciation message control unit 1010 in each device.

Subsequently, the configuration of the alternate relay management table 1002 will be described with reference to FIGS. 4, 5, and 6. The alternate relay management table 1002 holds an alternate relay group ID 10020, an alternate relay node ID 10021, and affiliation node IDs 10022, 10023. One alternate relay node ID 10021, and the plurality of affiliation node IDs 10022, 10023 can be held for one alternate relay group ID 10020. The alternate relay node ID 10021, and the affiliation node IDs 10022, 10023 are each configured by, for example, an identifier that uniquely determines the ad hoc wireless nodes 2n (n=0, 1, 2, . . . ) and the high-level relay 1n (n=0, 1, 2, . . . ) such as the MAC address.

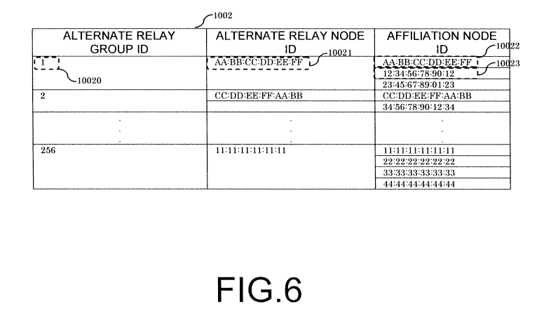

The alternate relay node ID 10021 is a node ID existing in the link table 1000. In an example of FIG. 6, the node ID 10000 on the link table 1000 is selected as the alternate relay node ID 10021. The affiliation node IDs 10022 and 10023 are final destination node IDs existing on the routing table 1001. In an example of FIG. 6, the affiliation node ID 10022 corresponds to the final destination node ID 10010, and the affiliation node ID 10023 corresponds to the final destination node ID 10012.

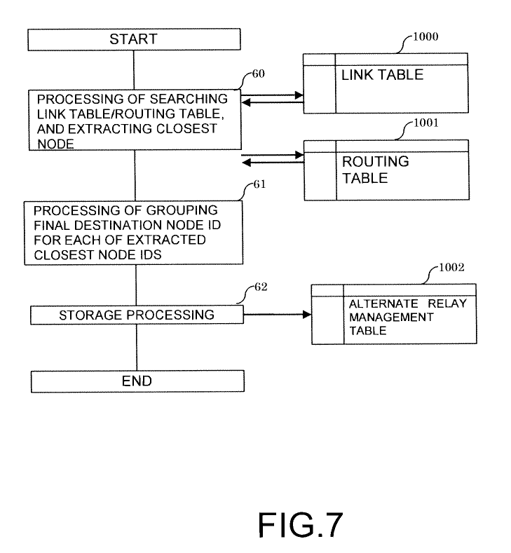

A configuration method of the alternate relay management table 1002 will be described with reference to FIGS. 6 and 7. In processing 60 of extracting the link table/routing table search and the closest node ID, the high-level relay 10 (for example, alternate relay management unit 1011, as the case may be) searches the link table 1000 and the routing table 1001, and extracts one of the node IDs designated by the closest node ID 10011. The routing table 1001 holds a plurality of the closest node IDs for one final destination node ID 10010. For example, the routing table 1001 extracts, as the closest node, the node IDs designed so that the electric wave reception intensity 10001 within the link table 1000 exemplified in FIG. 4 is higher than a predetermined reference, and the bidirectional link 10002 is established.

In processing 61 of grouping the final destination node ID for each of the extracted closest node IDs, the high-level relay 10 groups the final destination node IDs corresponding to the closest node ID extracted in the above technique into the same group. In storage processing 62, the high-level relay 10 stores the information grouped in the above procedure into the alternate relay management table 1002. For example, the extracted closest node IDs are registered into the alternate relay node IDs of the alternate relay management table 1002, and the corresponding final destination node IDs are registered in the affiliation node IDs of the alternate relay management table 1002. Also, the high-level relay 10 assigns the alternate relay group ID to each of the groups, and registers the group IDs in the alternate relay management table 1002. The above-mentioned processing is repeated, and the plurality of closest nodes are set as the alternate relay nodes to construct the plurality of alternate relay groups.

The alternate relay node ID 10021 that conducts grouping in the above technique conducts the meter reading information collection of the alternate relay node ID 10021 per se and the affiliation node IDs 10022, 10023 in place of the high-level relay 10.

### (Meter Reading Information Collection Processing)

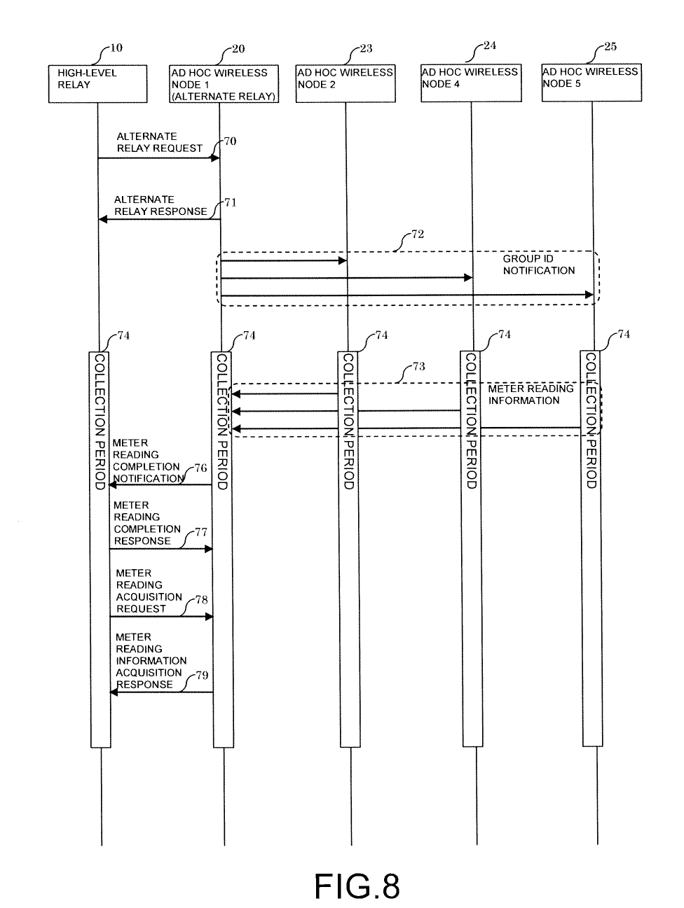

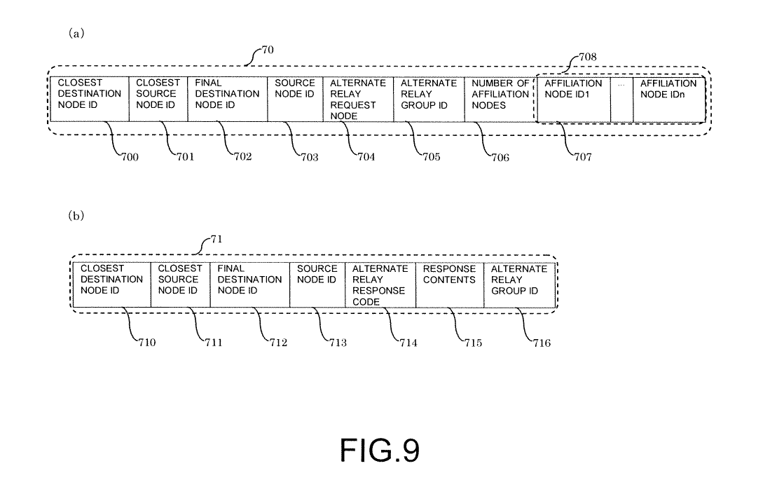

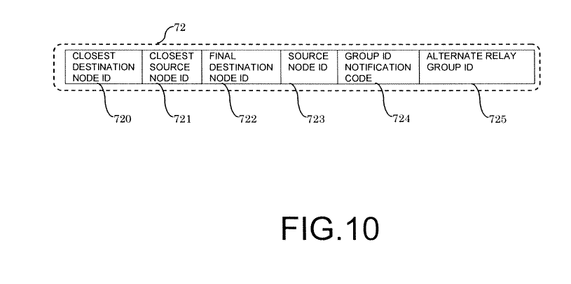

A sequence of the meter reading information collection of the high-level relay 10 and the ad hoc wireless nodes 20, 23, 24, and 25 is exemplified in FIG. 8, and will be described together with data formats of FIGS. 9, 10. 11, 12, and 13.

The high-level relay 10 that selects the alternate relays in the above technique transmits an alternate relay request 70 to the ad hoc wireless node selected as the alternate relay. The ad hoc wireless node 20 that receives the alternate relay request 70 returns an alternate relay response 71 to the high-level relay 10.

As exemplified in FIG. 9A, the alternate relay request includes a closest destination node ID 700, a final destination node ID 702, an alternate relay request code 704, a number of affiliation nodes 706, an alternate relay group ID705, and affiliation node IDn (n=1, 2, . . . ). Also, the alternate relay request 70 further includes a closest source node ID 701, and a source node ID 703. In an example of FIG. 9, the node IDs of the ad hoc wireless node 20 selected as the alternate relay are held in the closest destination node ID 700 of the alternate relay request 70. The node ID of the high-level relay 10 which is a closest source is held in the closest source node ID 701. The node ID of the ad hoc wireless node 20 selected as the alternate relay is held in the final destination node ID 702. The node ID of the high-level relay 10 which is the source is held in the source node ID 703. A predetermined integer value expressed as the alternate relay request is held in the alternate relay request code 704. A unique integer value specifying the group including the selected alternate relay is held in the alternate relay group ID 705. The number of ad hoc wireless nodes (the number of nodes belonging to the group) that the ad hoc wireless node 20 selected as the alternate relay conducts the meter reading information collection by deputy is held in the number of affiliation nodes 706. The node IDs of the ad hoc wireless nodes 20, 23, 24, and 25 that the ad hoc wireless node 20 selected as the alternate relay conducts the meter reading information collection by deputy are held in an affiliation node ID 707 as the respective information.

The affiliation node ID 707 holds all 708 of the ad hoc wireless nodes belonging to the group. The closest destination node ID 700 and the final destination node ID 702 enter the same value, and take, for example, a value of the alternate relay node ID 10021 in FIG. 6. The closest source node ID 701 and the source node ID 703 enter the same value, and take, in this case, a value of the node ID of the high-level relay 10. The alternate relay group ID 705 takes, for example, a value of the alternate relay group ID 10020 in FIG. 6.

On the other hand, in an example of FIG. 9B, the node ID of the high-level relay 10 is held in a closest node ID 710 of the alternate relay response 71. The node ID of the ad hoc wireless node 20 which is the closest source is held in a closest source node ID 711. The node ID of the high-level relay 10 is held in a final destination node ID 712. The node ID of the ad hoc wireless node 20 which is the source is held in a source node ID 713. A predetermined integer value expressed as the alternate relay response is held in an alternate relay response code 714. A predetermined integer value specifying an affirmative response is held in response contents 715. A unique integer value specifying the group of the alternate relay is held in an alternate relay group ID 716 as the respective information.

The closest destination node ID 710 and the final destination node ID 712 enter the same value, and in this case take the node ID of the high-level relay 10 as a value. The closest source node ID 701 and the source node ID 703 enter the same value, and correspond to, for example, a value of the alternate relay node ID 10021 in FIG. 6. The alternate relay group ID 716 corresponds to, for example, a value of the alternate relay group ID 10020 of FIG. 6.

The ad hoc wireless node 20 that acquires the information of the ad hoc wireless nodes 23, 24, and 25 which conduct the meter reading information collection by deputy by the alternate relay request 70 and the alternate relay response 71 transmit a group ID notification 72 to the ad hoc wireless nodes 23, 24, and 25 which are the affiliation nodes, as illustrated in FIG. 8.

FIG. 10 illustrates an example of the group ID notification 72. In an example of FIG. 10, in a closest node ID 720 of the group ID notification 72, the routing table 1001 exemplified in FIG. 5 of the ad hoc wireless node 20 selected as the alternate relay is searched, and the ID of one closest node selected from the closest nodes with the ad hoc wireless nodes 23, 24, and 25 as the final destination node is held. In a closest source node ID 721, the node ID of the ad hoc wireless node 20 selected as the alternate relay which is the closest source is held. In a final destination node ID 722, the node IDs of the ad hoc wireless nodes 23, 24, and 25 are held. In a source node ID 723, the node ID of the ad hoc wireless node 20 selected as the alternate relay is held. In a group ID notification code 724, a predetermined integer value expressed as the group ID notification is held. In an alternate relay group ID 725, a unique integer value that specifies the group of the alternate relay is held, as the respective information.

The ad hoc wireless nodes 23, 24, and 25 that receive the group ID notification 72 store the source node ID 723 (that is, ID of the alternate relay) and the alternate relay group ID 725 in the alternate relay information management table 1003 respectively therein.

When a preset meter reading information collection period 74 expires, the ad hoc wireless nodes 23, 24, and 25 transmit meter reading information 73 to the ad hoc wireless node 20 selected as the alternate relay. The meter reading collection period may have a time duration, or a clock time may be determined for each of the ad hoc wireless nodes. The meter reading information is measured by the smart meter function unit 203. The meter reading information may be measured when transmitting the information to the ad hoc wireless node 20, or information measured at an appropriate timing may be stored.

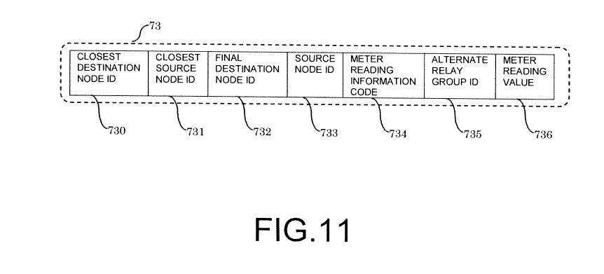

FIG. 11 illustrates an example of the meter reading information 73. In an example of FIG. 11, in a closest node ID 730 of the meter reading information 73, the routing table 1001 exemplified in FIG. 5 of the source per se is searched, and the ad hoc wireless node 20 selected as the alternate relay is set as the final destination node, and one closest node selected from the closest node is held. In a closest source node 731, the node ID of the ad hoc wireless node of the source per se is held. In a closest destination node ID 732, the node ID of the ad hoc wireless node 20 which is the alternate relay that conducts the meter reading information collection by deputy. In a source node ID 733, the node ID of the ad hoc wireless node of the source per se is held. In a meter reading information code 734, a predetermined integer value expressed as the meter reading information collection information is held. In an alternate relay group ID 735, a unique integer value that specifying the group of the alternate relay is held. In a meter reading value 736, the meter reading value acquired by the meter reading control unit 2030 shown in the functional block diagram of FIG. 3 is held as the respective information. The node ID of the ad hoc wireless node 20 which is the alternate relay, and the unique integer value specifying the group of the alternate relay can use information stored in conducting the above group ID notification.

Thus, the ad hoc wireless node 20 which is the alternate relay receives the meter reading information from the respective ad hoc wireless nodes belonging to the alternate relay group. The ad hoc wireless node 20 that collects the meter reading information in the above procedure by deputy holds the meter reading information of the ad hoc wireless nodes 20, 23, 24, and 25 in the meter reading information holding table 1004. Then, a meter reading completion notification 76 is transmitted to the high-level relay 10. As an example, the alternate relay receives the meter reading information from all of the affiliation nodes, acquires the meter reading information by the smart meter function block of itself, and then transmits the meter reading completion notification. The high-level relay 10 that receives the meter reading completion notification 76 returns a meter reading completion response 77 to the ad hoc wireless node 20 selected as the alternate relay.

The ad hoc wireless node 20 selected as the alternate relay returns a meter reading information acquisition response 79 to a meter reading information acquisition request 78 from the high-level relay 10. The meter reading information acquisition request 78 can be transmitted, for example, so that the high-level relay 10 can sequentially collect the meter reading information from the plurality of alternate relays. Also, the high-level relay 10 may control the timing of the meter reading information acquisition request to transmit to the plurality of alternate relays according to the electric wave environment. Alternatively, the meter reading information acquisition request 78 may be transmitted at an appropriate timing.

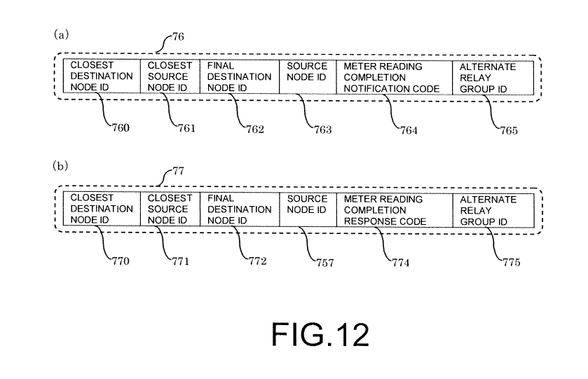

Referring to FIG. 12, the meter reading completion notification 76 and the meter reading completion response 77 will be described.

In a closest destination node ID 760 of the meter reading completion notification 76, the node ID of the high-level relay 10 is held. In a closest source node ID761, the node ID of the ad hoc wireless node 20 which is the closest source is held. In a final destination node ID 762, the node ID of high-level relay 10 is held. In a source node ID 763, the node ID of the ad hoc wireless node 20 which is the source is held. In a meter reading completion notification code 764, a predetermined integer value expressed as the meter reading completion notification is held. In an alternate relay group ID 765, a unique integer value specifying the group of the alternate relay is held as the respective information.

Also, in a closest destination node ID 770 of the meter reading completion response 77, the node ID of the ad hoc wireless node 20 selected as the alternate relay is held. In a closest source node ID771, node ID of the high-level relay 10 which is the closest source is held. In a final destination node ID 772, the node ID of the ad hoc wireless node 20 selected as the alternate relay is held. In a source node ID 773, the node ID of the high-level relay 10 which is the source is held. In a meter reading completion response code 774, the predetermined integer value expressed as the meter reading completion response is held. In an alternate relay group ID 755, a unique integer value specifying the group of the alternate relay is held as the respective information.

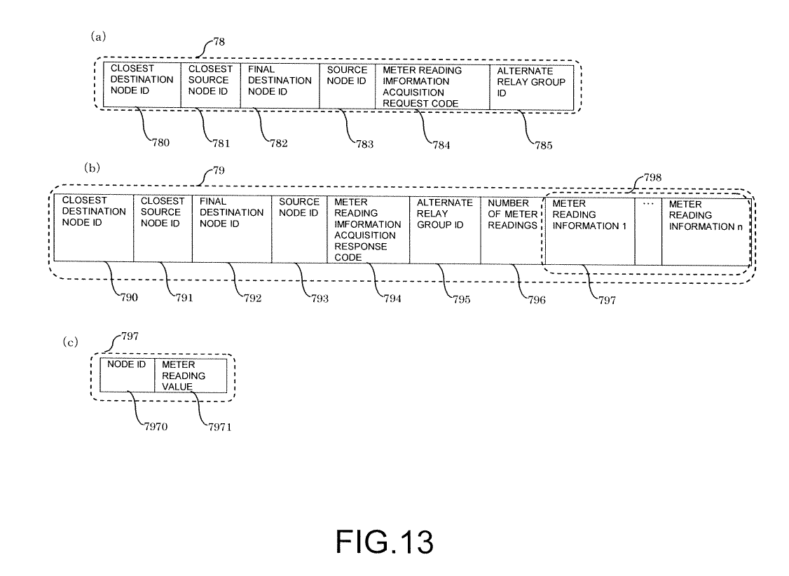

Referring to FIG. 13, the meter reading information acquisition request 78 and the meter reading information acquisition response 79 will be described.

In a closest destination node ID 780 of the meter reading acquisition request 78, the node ID of the ad hoc wireless node 20 selected as the alternate relay is held. In a closest source node ID781, the node ID of the high-level relay 10 which is the closest source is held. In a final destination node ID 782, the node ID of the ad hoc wireless node 20 selected as the alternate relay is held. In a source node ID 783, the node ID of the high-level relay 10 which is the source is held. In a meter reading acquisition request code 784, the predetermined integer value expressed as the meter reading information acquisition request is held. In an alternate relay group ID 785, a unique integer value specifying the group of the alternate relay is held as the respective information.

In a closest destination node ID 790 of the meter reading information acquisition response 79, the node ID of the high-level relay 10 is held. In a closest source node ID791, the node ID of the ad hoc wireless node 20 which is the closest source is held. In a final destination node ID 792, the node ID of the high-level relay 10 is held. In a source node ID 793, the node ID of the ad hoc wireless node 20 which is the source is held. In a meter reading information acquisition response code 794, the predetermined integer value expressed as the meter reading information acquisition response is held. In an alternate relay group ID 795, a unique integer value specifying the group of the alternate relay is held. In a meter reading number 796, a sum (that is, the number of receptions+1) of the ad hoc wireless node 20 which is the alternate relay of the source per se and the number of receptions of the meter reading information 73 received from the ad hoc wireless nodes 23, 24, and 25 is held. In a meter reading information 797, the respective meter reading information of the ad hoc wireless nodes 20, 23, 24, and 25 is held as the respective information.

The meter reading information 797 holds all 798 of the ad hoc wireless nodes including the ad hoc wireless node 20 which is the alternate relay. The meter reading information 797 includes a node ID 7970 of the ad hoc wireless nodes that transmit the meter reading value, and a meter reading value 7971.

In meter reading information acquisition response 79, as disclosed in FIG. 13B, the meter reading information 797 holds all of the ad hoc wireless nodes including the ad hoc wireless nodes 20 which is the alternate relays (798), and packs the meter reading information from the ad hoc wireless nodes into one message, and transmits the message.

### (Multi-Cast Processing)

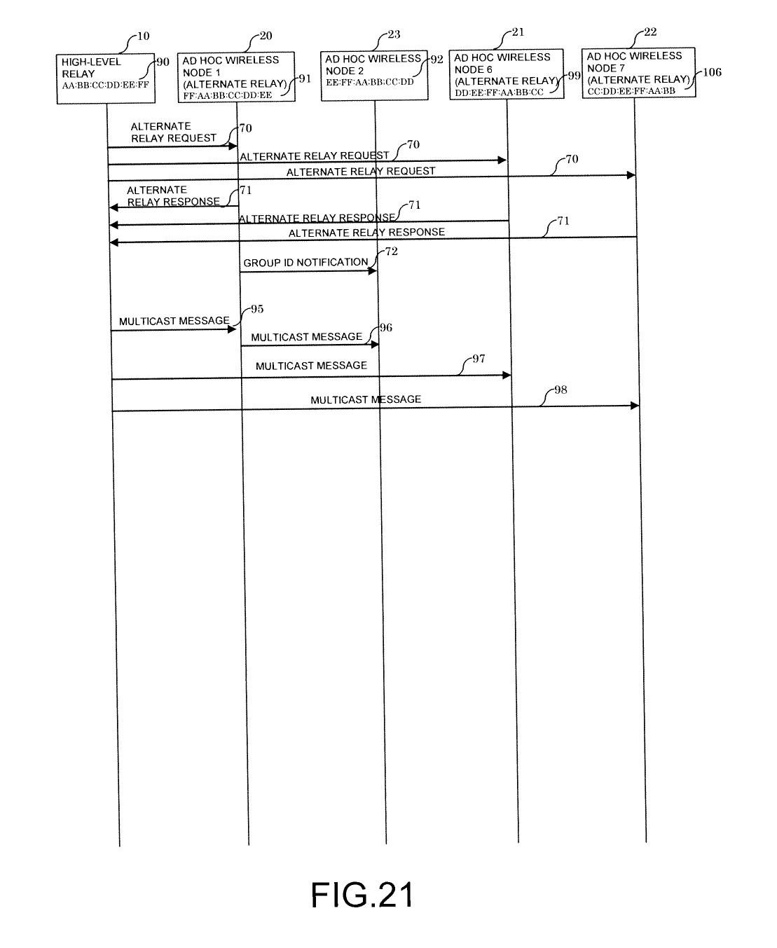

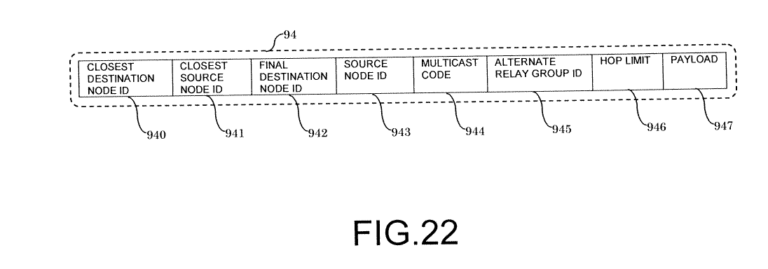

Referring to FIGS. 21 and 22, the transfer sequence of a multicast message and a multicast message format will be described.

The high-level relay 10 and the ad hoc wireless nodes 20, 21, 22, and 23 share the determination of the group ID by the communication of the above alternate relay request 70, the alternate relay response 71, and the group ID notification 72. In this example, the ad hoc wireless nodes 20, 21, and 22 are the alternate relays, and the ad hoc wireless node 23 is a node belonging to the same group as that of the ad hoc wireless node 20.

In this embodiment, the alternate relay group ID is assigned to the multicast message, and transferred into the alternate relay group. If the alternate relay group ID included in the received multicast message is different from the alternate relay group ID to which the subject device belongs, the alternate relay group ID is discarded without being transferred. As a result, in the ad hoc wireless network, the multicast message can be efficiently transmitted with the use of the alternate relay group ID.

The high-level relay 10 and the respective ad hoc wireless nodes transmit the multicast messages according to the format of a multicast message 94 illustrated in FIG. 22. In the multicast message 94, in a closest destination node ID 940, the address information indicating the multicast is held. In a closest source node ID 941, the high-level relay 10 which is the closest source, or the node ID of the ad hoc wireless node is held. In a final destination node ID 942, the address information representing the multicast is held. In a source node ID 943, the node ID of the high-level relay 10 which is the source is held. In a multicast code 944, a predetermined integer value expressed as the multicast is held. In a group ID 945, the group ID that is a target of the multicast is held. In a hop limit 946, the largest number of hops that transmits the multicast is held. In a payload 947, data per se to be delivered by the multicast is held as the respective information. Data to be delivered by the multicast may be multicast data received from other servers or devices, or may be control information of the ad hoc network. The ad hoc wireless node that receives the multicast message 94 subtracts the hop limit 946 at the time of transfer by one. If the hop limit is 0, transfer is no more executed.

In an example of FIG. 21, the ad hoc wireless node 20 and the ad hoc wireless node 23 belong to the same alternate relay group, and the ad hoc wireless node 21 and the ad hoc wireless node 22 belong to the different alternate relay groups.

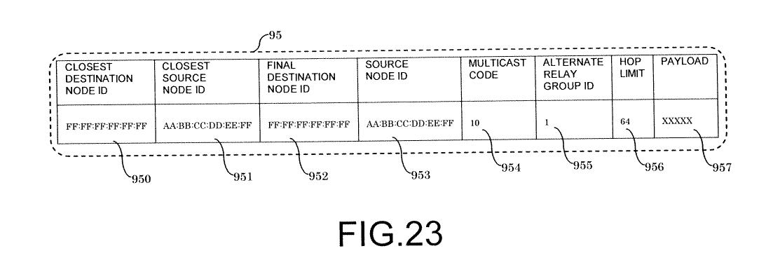

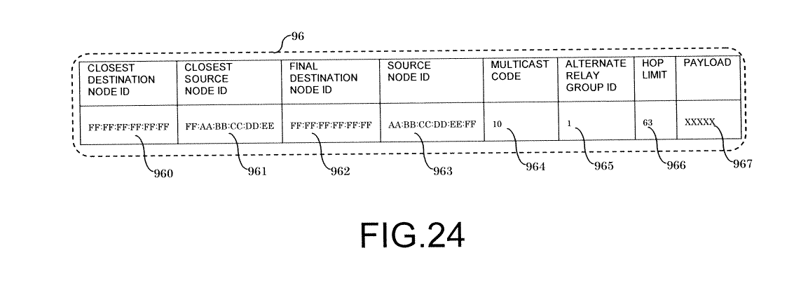

The ad hoc wireless node 20 that receives the multicast message 95 illustrated in FIG. 23 from the high-level relay 10 subtracts the hop limit by one, and transmits the message as a multicast message 96 illustrated in FIG. 24. On other hand, the ad hoc wireless nodes 20 and 23 may receive a multicast message 97 or a multicast message 98 by the electric wave state. In the ad hoc wireless nodes 20 and 23, the group ID notified by the alternate relay request or the group ID notification is different from the alternate relay group ID within the message, and therefore the messages are discarded without being transferred.

The ad hoc wireless node 23 that receives the multicast message 96 illustrated in FIG. 24 subtracts a hop limit 966 by one, and transfers the message.

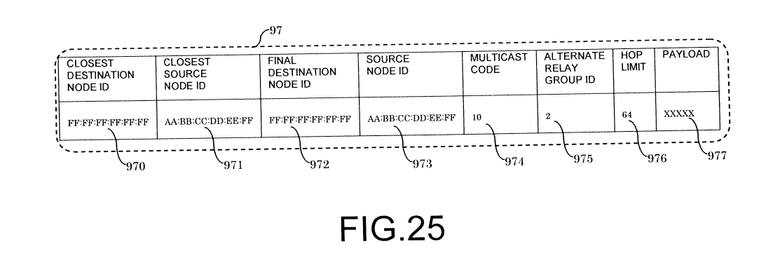

The ad hoc wireless node 21 that receives the multicast message 97 illustrated in FIG. 25 from the high-level relay 10 subtracts a hop limit 976 by one, and transfers the message. Even when the ad hoc wireless nodes 20, 22, and 23 other than the ad hoc wireless node 21 receive the multicast message 97, the alternate relay group ID is different from each other, the multicast message 97 is discarded.

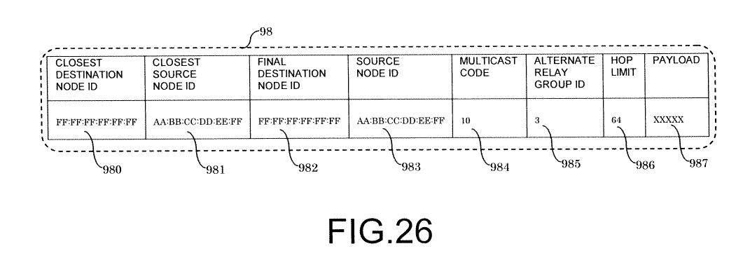

The ad hoc wireless node 22 that receives the multicast message 98 illustrated in FIG. 26 from the high-level relay 10 subtracts a hop limit 986 by one, and transfers the message. Even when the ad hoc wireless nodes 20, 21, and 23 other than the ad hoc wireless node 22 receive the multicast message 98, because the alternate relay group ID is different from each other, the multicast message 98 is discarded.

### CONFIGURATION

### CONFIGURATION EXAMPLE 1

The mesh ad hoc network is configured by, for example, a mesh ad hoc network including a plurality of high-level relays and a plurality of ad hoc wireless nodes each having a smart meter function unit,

in a communication system where the high-level relays and the ad hoc wireless nodes each having the smart meter function unit each have a function of conducting a wireless communication,

a link table and a routing table are configured by mutual communications of an annunciation message, and

a multihop communication is conducted with reference to the link table and the routing table, in which

each of the high-level relays has a function unit of collecting meter reading information of the ad hoc wireless nodes each having the smart meter function unit by the ad hoc wireless nodes each having the smart meter function unit through the mesh ad hoc network, and

each of the high-level relays has a function of delegating a meter reading information collection of the ad hoc wireless nodes each having the smart meter function unit to the ad hoc wireless nodes each having the smart meter function unit of one hop from the high-level relay through the mesh ad hoc network.

### CONFIGURATION EXAMPLE 2

In the mesh ad hoc network according to the configuration example 1,

each of the high-level relays has a unit of searching a link table and a routing table which are held inside of the high-level relay, and determining the ad hoc wireless nodes each having the smart meter function unit of one hop from the high-level relay that relegates the delegation of the meter reading information collection, when delegating the meter reading information collection to the ad hoc wireless nodes each having the smart meter function unit of one hop from the high-level relay, and holds the information as internal storage.

### CONFIGURATION EXAMPLE 3

In the mesh ad hoc network according to the configuration example 1,

each of the high-level relays has a unit of searching a link table and a routing table which are held inside of the high-level relay, and determining a list of the ad hoc wireless nodes each having the smart meter function unit of one or more hops from the high-level relay that actually acquires the meter reading information, when delegating the meter reading information collection to the ad hoc wireless nodes each having the smart meter function unit of one hop from the high-level relay, and holds the information as internal storage.

### CONFIGURATION EXAMPLE 4

In the mesh ad hoc network according to the configuration example 1,

each of the high-level relays has a function of delivering the ad hoc wireless nodes each having the smart meter function unit of one hot from the high-level relay that relegates delegation of the meter reading information collection according to the configuration example 2, and

a list of the ad hoc wireless nodes each having the smart meter function unit of one or more hops from the high-level relay that actually acquires the meter reading information according to the configuration example 3

to the ad hoc wireless nodes each having the smart meter function unit of one hop from the high-level relay as an alternate relay response.

### CONFIGURATION EXAMPLE 5

In the mesh ad hoc network according to the configuration example 1,

the ad hoc wireless node having the smart meter function unit of one hop from the high-level relay, which receives information on the ad hoc wireless node having the smart meter function unit of one hop from the high-level relay that relegates the delegation of the meter reading information collection according to the configuration example 2, and

the list of the ad hoc wireless nodes each having the smart meter function unit of one or more hops from the high-level relays that actually acquire the meter reading information according to the configuration example 3

includes the smart meter function unit having a function of returning a response to the high-level relays as an alternate relay response.

### CONFIGURATION EXAMPLE 6

In the mesh ad hoc network according to the configuration example 1,

the ad hoc wireless node having the smart meter function unit of one hop from the high-level relay, which receives information on the ad hoc wireless node having the smart meter function unit of one hop from the high-level relay that relegates the delegation of the meter reading information collection according to the configuration example 2, and

the list of the ad hoc wireless nodes each having the smart meter function unit of one or more hops from the high-level relays that actually acquire the meter reading information according to the configuration example 3,

includes a smart meter function unit

holding the information as internal storage, and

having a function of notifying all of the ad hoc wireless nodes on the list of the ad hoc wireless nodes each having the smart meter function unit of one or more hops from the high-level relay that acquires the meter reading information, as a group ID notification.

### CONFIGURATION EXAMPLE 7

In the mesh ad hoc network according to the configuration example 1,

the ad hoc wireless node having the smart meter function unit of one or more hops from the high-level relay that receives the group ID notification according to the configuration example 6 includes a smart meter function unit having a mechanism of transmitting the meter reading information during the meter reading information collection period to the ad hoc wireless node having the smart meter function unit of one hop from the high-level relay which receives the delegation of the meter reading information collection from the high-level relay according to the configuration example 2.

### CONFIGURATION EXAMPLE 8

In the mesh ad hoc network according to the configuration example 1,

the ad hoc wireless node having the smart meter function unit of one hop from the high-level relay which receives the delegation of the meter reading information collection from the high-level relay according to the configuration example 2

includes a smart meter function unit having a function of receiving the meter reading information from the ad hoc wireless node having the smart meter function unit of one or more hops from the high-level relay that receives the group ID notification according to the configuration example 7.

### CONFIGURATION EXAMPLE 9

In the mesh ad hoc network according to the configuration example 1,

the ad hoc wireless node having the smart meter function unit of one hop from the high-level relay which receives the delegation of the meter reading information collection from the high-level relay that receives the meter reading information according to the configuration example 8

includes a smart meter function unit having a function of holding the meter reading information in an internal storage.

### CONFIGURATION EXAMPLE 10

In the mesh ad hoc network according to the configuration example 1,

the ad hoc wireless node having the smart meter function unit of one hop from the high-level relay which receives the delegation of the meter reading information collection from the high-level relay that holds the meter reading information in the internal storage according to the configuration example 9

includes a smart meter function unit having a function of transmitting a meter reading completion notification to the high-level relay.

### CONFIGURATION EXAMPLE 11

In the mesh ad hoc network according to the configuration example 1,

the high-level relay that receives the meter reading completion notification according to the configuration example 10

includes a function of transmitting a meter reading information completion response to the ad hoc wireless node having the smart meter function unit of one hop from the high-level relay that receives the delegation of the meter reading information collection from the high-level relay.

### CONFIGURATION EXAMPLE 12

In the mesh ad hoc network according to the configuration example 1,

the high-level relay that receives the meter reading completion notification according to the configuration example 10

includes a function of transmitting a meter reading information acquisition request to the ad hoc wireless node having the smart meter function unit of one hop from the high-level relay that receives the delegation of the meter reading information collection from the high-level relay.

### CONFIGURATION EXAMPLE 13

In the mesh ad hoc network according to the configuration example 1,

the ad hoc wireless node having the smart meter function unit of one hop from the high-level relay that receives the delegation of the meter reading information collection from the high-level relay, which receives the meter reading information acquisition request according to the configuration example 11,

includes a smart meter function unit having a function of packing the meter reading information held in the internal storage according to the configuration example 9 into one message, and returning the message to the high-level relay as a meter reading information acquisition response.

### CONFIGURATION EXAMPLE 14

In the mesh ad hoc network according to the configuration example 1,

the ad hoc wireless node to which the alternate relay group ID is assigned by the means of the configuration example 5 and the configuration example 6

subtracts, when receiving the multicast packet of the alternate relay group ID to which the subject ad hoc wireless node belongs, a hop limit from the multicast packet, and transfers the multicast packet, and

discards the multicast packet when receiving the multicast packet of the alternate relay group ID to which the subject ad hoc wireless node does not belong.

The present invention is available to, for example, an ad hoc wireless network system.

What is claimed is:

1. An ad hoc network system, comprising:
a plurality of ad hoc wireless nodes each having a smart meter function unit that measures and transmits meter reading information; and
a high-level relay that receives the meter reading information from the ad hoc wireless nodes,
wherein
the high-level relay selects one or a plurality of ad hoc wireless nodes, of one hop from the subject high-level relay as an alternate relay,
the high-level relay groups the ad hoc wireless nodes that communicate with each other through the alternate relay, and
the high-level relay transmits an alternate relay request including identification information of the grouped ad hoc wireless nodes to the alternate relay,
the alternate relay transmits identification information of the subject alternate relay to the grouped ad hoc wireless nodes,
each of the grouped ad hoc wireless nodes transmits the meter reading information measured by the smart meter function unit to the alternate relay, and
the alternate relay receives the respective meter reading information from the grouped plurality of ad hoc wireless nodes, and transmits the received respective meter reading information and the meter reading information measured by a smart meter storage unit of the subject alternate relay to the high-level relay in a lump.

2. The ad hoc network system according to claim 1,
the high-level relay includes:
a routing table that manages an identifier of a closest ad hoc wireless node that communicates with the subject high-level relay by one hop, and an ad hoc wireless node of a destination that communicates through the closest ad hoc wireless node by multihop, and
wherein the high-level relay selects the closest ad hoc wireless node that communicates with the subject high-level relay by one hop as the alternate relay, with reference to the routing table.

3. The ad hoc network system according to claim 2,
wherein the high-level relay groups the ad hoc wireless node of the destination with the selected alternate relay as the closest ad hoc wireless node, as the ad hoc wireless node belonging to the same group as that of the alternate relay, with reference to the routing table.

4. The ad hoc network system according to claim 1,
the high-level relay further includes:
a link table that manages an identifier of the ad hoc wireless node that communicates with the subject high-level relay by one hop, and communication quality information measured when communicating with the ad hoc wireless node, and
wherein the high-level relay selects the ad hoc wireless node whose communication quality information exceeds a predetermined reference among the ad hoc wireless nodes that communicate with the subject high-level relay by one hop, as the alternate relay, with reference to the link table.

5. The ad hoc network system according to claim 1,
wherein the alternate relay stores the respective meter reading information received from the grouped plurality of ad hoc wireless nodes, and meter reading information measured by a smart meter storage unit of the subject alternate relay,
the high-level relay transmits a meter reading information acquisition request to the alternate relay, and
the alternate relay transmits the respective meter reading information to the high-level relay according to the meter reading information acquisition request in a lump.

6. The ad hoc network system according to claim 1,
wherein the alternate relay packs the respective meter reading information into one message, and transmits the one message to the high-level relay.

7. The ad hoc network system according to claim 1,
wherein
the high-level relay assigns a group identifier to each group of the ad hoc wireless nodes, and transmits the group identifier to the alternate relay and the grouped ad hoc wireless nodes,
the high-level relay gives a multicast packet the group identifier, and transmits the multicast packet,
the alternate relay that receives the multicast packet transfers the multicast packet to another ad hoc wireless node if the given group identifier matches the group identifier of the group to which the subject alternate relay belongs, and discards the multicast packet if not.

8. The ad hoc network system according to claim 7,
Wherein, when transferring the multicast packet, the alternate relay subtracts hop limit information included in the multicast packet, and transfers the multicast packet.

9. The ad hoc network system according to claim 7,
wherein the ad hoc wireless node that receives the multicast packet transfers the multicast packet to another ad hoc wireless node if the given group identifier matches the group identifier of the group to which the subject ad hoc wireless node belongs, and discards the multicast packet if not.

10. The ad hoc network system according to claim 9,
Wherein, when transferring the multicast packet, the ad hoc wireless node subtracts hop limit information included in the multicast packet, and transfers the multicast packet.

11. A meter reading information collecting method in an ad hoc network system, comprising:
a plurality of ad hoc wireless nodes each having a smart meter function unit that measures and transmits meter reading information; and
a high-level relay that receives the meter reading information from the ad hoc wireless nodes,
wherein
the high-level relay selects one or a plurality of ad hoc wireless nodes, of one hop from the subject high-level relay as an alternate relay,
the high-level relay groups the ad hoc wireless nodes that communicate with each other through the alternate relay, and
the high-level relay transmits an alternate relay request including identification information of the grouped ad hoc wireless nodes to the alternate relay,
the alternate relay transmits identification information of the subject alternate relay to the grouped ad hoc wireless nodes,
each of the grouped ad hoc wireless nodes transmits the meter reading information measured by the smart meter function unit to the alternate relay, and
the alternate relay receives the respective meter reading information from the grouped plurality of ad hoc wireless nodes, and transmits the received respective meter reading information and the meter reading information measured by a smart meter storage unit of the subject alternate relay to the high-level relay in a lump.

12. The meter reading information collecting method according to claim 11,
the high-level relay includes:
a routing table that manages an identifier of a closest ad hoc wireless node that communicates with the subject high-level relay by one hop, and an ad hoc wireless node of a destination that communicates through the closest ad hoc wireless node by multihop, and
wherein the high-level relay selects the closest ad hoc wireless node that communicates with the subject high-level relay by one hop as the alternate relay, with reference to the routing table.

13. The meter reading information collecting method according to claim 11,
the high-level relay further includes:
a link table that manages an identifier of the ad hoc wireless node that communicates with the subject high-level relay by one hop, and communication quality information measured when communicating with the ad hoc wireless node, and
wherein the high-level relay selects the ad hoc wireless node whose communication quality information exceeds a predetermined reference among the ad hoc wireless nodes that communicate with the subject high-level relay by one hop, as the alternate relay, with reference to the link table.

14. The meter reading information collecting method according to claim 11,
wherein the alternate relay stores the respective meter reading information received from the grouped plurality of ad hoc wireless nodes, and meter reading information measured by a smart meter storage unit of the subject alternate relay,
the high-level relay transmits a meter reading information acquisition request to the alternate relay, and
the alternate relay transmits the respective meter reading information to the high-level relay according to the meter reading information acquisition request in a lump.

15. The meter reading information collecting method according to claim 11,
wherein the alternate relay packs the respective meter reading information into one message, and transmits the one message to the high-level relay.

16. The meter reading information collecting method according to claim 11,
wherein
the high-level relay assigns a group identifier to each group of the ad hoc wireless nodes, and transmits the group identifier to the alternate relay and the grouped ad hoc wireless nodes,
the high-level relay gives a multicast packet the group identifier, and transmits the multicast packet,
the alternate relay that receives the multicast packet transfers the multicast packet to another ad hoc wireless node if the given group identifier matches the group identifier of the group to which the subject alternate relay belongs, and discards the multicast packet if not.
